(19) United States
(12) Patent Application Publication
(10) Pub. No.: US 2014/0092529 A1
(43) Pub. Date: Apr. 3, 2014

(54) ELECTROCONDUCTIVE POLYMER SOLUTION AND METHOD FOR PRODUCING THE SAME, ELECTROCONDUCTIVE POLYMER MATERIAL, AND SOLID ELECTROLYTIC CAPACITOR USING THE SAME AND METHOD FOR PRODUCING THE SAME

(71) Applicants: Tomoki Nobuta, Sendai-shi (JP); Yasuhisa Sugawara, Sendai-shi (JP); Yuji Yoshida, Sendai-shi (JP); Satoshi Suzuki, Sendai-shi (JP); Yasuhiro Tomioka, Sendai-shi (JP)

(72) Inventors: Tomoki Nobuta, Sendai-shi (JP); Yasuhisa Sugawara, Sendai-shi (JP); Yuji Yoshida, Sendai-shi (JP); Satoshi Suzuki, Sendai-shi (JP); Yasuhiro Tomioka, Sendai-shi (JP)

(73) Assignee: NEC TOKIN CORPORATION, Sendai-shi, Miyagi (JP)

(21) Appl. No.: 14/001,034

(22) PCT Filed: Feb. 27, 2012
(86) PCT No.: PCT/JP2012/054718

§ 371 Date: Dec. 18, 2013

(30) Foreign Application Priority Data
Feb. 28, 2011 (JP) 2011-041168

(51) Int. Cl. H01G 9/028; H01G 9/00

(52) U.S. Cl. CPC H01G 9/028; H01G 9/0036
USPC 361/527; 361/525; 252/62.2; 427/80

(57) ABSTRACT

Provided are an electroconductive polymer solution in which the carbon material has excellent dispersibility, an electroconductive polymer material which has a high electroconductivity and which can be produced by a simple method, and a solid electrolytic capacitor and a method for producing the same which has a low ESR without increasing a leakage current. An electroconductive polymer solution according to an exemplary embodiment of the invention contains an electroconductive polymer, a polysulfonic acid or a salt thereof which functions as a dopant to the electroconductive polymer, a mixture of a polyacid and a carbon material, and a solvent.

### TECHNICAL FIELD

The present invention relates to an electroconductive polymer solution and a method for producing the same, an electroconductive polymer material, and a solid electrolytic capacitor using the same and a method for producing the same. More particularly, the present invention relates to an electroconductive polymer solution containing a carbon material, an electroconductive polymer material having a high electroconductivity, and a solid electrolytic capacitor using the same and a method for producing the same which has a low equivalent series resistance (hereinafter, referred to as ESR) without increasing a leakage current.

### BACKGROUND ART

Electroconductive organic materials are used for antistatic materials, electromagnetic shielding materials, electrodes of condensers and electrochemical capacitors, electrodes of dye-sensitization solar cells, organic thin film solar cells, and the like, electrodes of electroluminescence displays, and the like. As the electroconductive organic material, electroconductive polymers obtained by polymerizing pyrrole, thiophene, 3,4-ethylenedioxythiophene, aniline, or the like are known.

The electroconductive polymer is generally provided in the market as an electroconductive polymer solution in which the electroconductive polymer is dispersed or melted in an aqueous solvent or an organic solvent, and the solvent is removed at the time of use, and the electroconductive polymer material is used. In late years, an electroconductive polymer material having a higher electroconductivity is demanded, and various studies are conducted.

Also, a solid electrolytic capacitor, which is obtained by forming a dielectric oxide film on a porous body of a valve metal such as tantalum or aluminum by anodic oxidation method and thereafter by forming an electroconductive polymer layer on this oxide film to be used as a solid electrolyte layer, is developed.

Examples of the method for forming an electroconductive polymer layer that comes to be a solid electrolyte layer of this solid electrolytic capacitor include a method for polymerizing a monomer by chemical oxidation and electrolytic oxidation and a method for forming it using an electroconductive polymer solution. As the electroconductive polymer material that comes to be the electroconductive polymer layer, polymers of pyrrole, thiophene, 3,4-ethylenedioxythiophene, aniline, and the like are known.

Since the solid electrolytic capacitor has a lower ESR than that of a capacitor in which manganese dioxide is used as a solid electrolyte layer, it begin to be used for various purposes. In late years, with downsizing and weight saving of electronic devices as well as higher frequency of integrated circuits, a solid electrolytic capacitor having a small size, a large capacity and a small loss is demanded, and studies for further reducing the ESR is advanced.

Patent Document 1 discloses that, in a solid electrolytic capacitor in which an electroconductive polymer film was laminated on an element where an oxide film is formed on a valve metal, an electroconductive polymer solution containing a carbon is applied to provide an electroconductive polymer film on at least the surface portion, and thereby the properties such as tan δ and the leakage current of the solid electrolytic capacitor can be improved.

Patent Document 2 discloses that a solid electrolyte layer having excellent electroconductivity and heat resistance can be formed by simple steps such as application and dry, by using an electroconductive composition which contains an electroconductive mixture containing a cyano group-containing polymer compound and a π-conjugated electroconductive polymer and an electroconductive filler.

Patent Document 3 discloses that the ESR can be decreased without changing the leakage current by having a capacitor element in which an anode body, a dielectric coating film formed on a surface of the anode, an electroconductive polymer layer formed on the dielectric coating film, and a mixture layer containing an electroconductive matrix and a carbon nanotube formed on the electroconductive polymer layer are sequentially laminated, and that a solid electrolytic capacitor having high reliability can be obtained.

Patent Document 4 discloses a composition containing a mixture of a colloidal electroconductive polymer and carbon, by which a coating can be formed, a method for producing the same, and a use of the composition for an electric double layer capacitor. It is disclosed as a method for mixing a colloidal electroconductive polymer with a carbon material that a carbon material is finely pulverized by a ball mill or the like as a pretreatment and was then mixed, that the carbon material is previously dispersed in a medium such as water or an organic solvent and was added to a colloidal dispersion of the electroconductive polymer, or that it is dispersed in a ball mill in the presence of a colloidal dispersion of the electroconductive polymer. It is disclosed that the composition can be produced with repeatability by this method.

Patent Document 5 discloses a technology regarding an electroconductive polymer solution which contains π-conjugated electroconductive polymer, a polyanion, an electroconductive carbon black, a solvent, in which the content of the electroconductive carbon black is 0.01 to 10 mass % when the total of the π-conjugated electroconductive polymer and the polyanion is 100 mass %. It is disclosed that an electroconductive coating film having excellent transparency which is suitable for a transparent electrode of the electrode sheet for touch panels can be provided by this electroconductive polymer solution.

### PRIOR ART DOCUMENT

### Patent Document

Patent Document 1: JP 9-320902 A
Patent Document 2: JP 2005-206657 A
Patent Document 3: JP 2010-153454 A
Patent Document 4: JP 2007-529586 A
Patent Document 5: JP 2009-93873 A

### SUMMARY OF THE INVENTION

### Problem to be Solved by the Invention

However, in the methods disclosed in Patent Documents 1, 2, 3, and 4, an electroconductive polymer such as a polyaniline and a proton acid or a low molecular organic sulfonic acid as a dopant to this are used. In these cases, it is difficult that a carbon material is uniformly dispersed with stability in the electroconductive polymer solution. In addition, in the method by physically mixing an electroconductive polymer solution with a carbon material, such as a method disclosed in Patent Document 4, for example, the carbon material must be finely pulverized to control the particle size of the carbon material, which results in complicating the production process.

Patent Document 5 discloses a method to disperse an electroconductive carbon black well by adding a surfactant or by controlling the pH, but the electroconductivity of the electroconductive polymer may be damaged. Also, the dispersed state of the electroconductive carbon black in the electroconductive polymer solution and the electroconductive coating film is not specifically disclosed.

Thus, in Patent Documents 1 to 5, an electroconductive polymer solution in which a carbon material is uniformly dispersed with stability is not obtained. Also, the technologies disclosed in Patent Documents 1 to 5 are not sufficient to the purposes to obtain an electroconductive polymer material having a high electroconductivity and a solid electrolytic capacitor having a low ESR.

The object of the present invention is to solve the above-mentioned problem, specifically to provide an electroconductive polymer solution in which the carbon material has excellent dispersibility, to provide an electroconductive polymer material which has a high electroconductivity and which can be produced by a simple method, and to provide a solid electrolytic capacitor and a method for producing the same which has a low ESR without increasing a leakage current.

### Means of Solving the Problem

In order to solve the above-mentioned problem, the electroconductive polymer solution according to the present invention contains an electroconductive polymer, a polysulfonic acid which functions as a dopant to the electroconductive polymer, a mixture of a polyacid and a carbon material, and a solvent.

The method for producing an electroconductive polymer solution according to the present invention is a method for producing the above-mentioned electroconductive polymer solution which includes: obtaining an electroconductive polymer by an oxidative polymerization using an oxidant in a solution which contains at least one monomer selected from the group consisting of pyrrole, thiophene, and derivatives thereof as a monomer providing an electroconductive polymer, a polysulfonic acid which functions as a dopant, and a solvent; and mixing a mixture of a polyacid and a carbon material with the electroconductive polymer.

Also, the method for producing an electroconductive polymer solution according to the present invention is a method for producing the above-mentioned electroconductive polymer solution which includes: obtaining an electroconductive polymer by an oxidative polymerization of at least one monomer selected from the group consisting of pyrrole, thiophene, and derivatives thereof as a monomer providing an electroconductive polymer using an oxidant in a solution which contains a mixture of a polyacid and a carbon material, a polysulfonic acid which functions as a dopant, and a solvent.

The electroconductive polymer material according to the present invention is obtained by removing the solvent from the electroconductive polymer solution according to the present invention.

The solid electrolytic capacitor according to the present invention includes an anode conductor containing a valve metal, an dielectric layer formed on a surface of the anode conductor, and a solid electrolyte layer formed on the dielectric layer, wherein the solid electrolyte layer contains the electroconductive polymer material according to the present invention.

The method for producing a solid electrolytic capacitor according to the present invention includes: forming a dielectric layer on a surface of an anode conductor containing a valve metal; carrying out an application of the electroconductive polymer solution according to the present invention on the dielectric layer, or carrying out an impregnation of the electroconductive polymer solution into the dielectric layer; and removing the solvent from the electroconductive polymer solution for the application or the impregnation to form a solid electrolyte layer containing an electroconductive polymer material.

Also, the method for producing a solid electrolytic capacitor according to the present invention includes: forming a dielectric layer on a surface of an anode conductor containing a valve metal; carrying out a chemical oxidation polymerization or an electropolymerization of a monomer that is a material of an electroconductive polymer on the dielectric layer, to form a first solid electrolyte layer containing the electroconductive polymer; carrying out an application of the electroconductive polymer solution according to the present invention on the first solid electrolyte layer, or carrying out an impregnation of the electroconductive polymer solution into first solid electrolyte layer; and removing the solvent from the electroconductive polymer solution for the application or the impregnation to form a second solid electrolyte layer containing an electroconductive polymer material according to the present invention.

### Effect of the Invention

According to the present invention, it is possible to obtain an electroconductive polymer solution in which the carbon material has excellent dispersibility and an electroconductive polymer material which has a high electroconductivity and which can be produced by a simple method, as well as to obtain a solid electrolytic capacitor and a method for producing the same which has a low ESR without increasing a leakage current.

### BRIEF DESCRIPTION OF DRAWING

FIG. 1 is a schematic enlarged sectional view showing a part of a conformation in one embodiment of the solid electrolytic capacitor according to the present invention.

### MODE FOR CARRYING OUT THE INVENTION

As follows, an embodiment of the present invention is explained in detail.

At first, an embodiment of the electroconductive polymer solution according to the present invention is explained. The electroconductive polymer solution according to the present invention contains an electroconductive polymer, a polysulfonic acid or a salt thereof which functions as a dopant to the electroconductive polymer, a mixture of a polyacid and a carbon material, and a solvent.

As a polyacid used for a mixture of a polyacid and a carbon material contained in the electroconductive polymer solution of the present invention, it is possible to use a polymer having an acidic hydrophilic group such as a sulfonic acid group or a carboxyl group. Specifically, polystyrene resins having a sulfonic acid group, polyvinyl resins having a sulfonic acid group, and polyester resins having a sulfonic acid group are preferable, and it is also possible to use a polyacid which is a similar or the same kind of a polysulfonic acid which functions as a dopant to an electroconductive polymer mentioned below.

Note that, the polyacid does not function as a dopant to an electroconductive polymer, and is used to make a carbon material dispersed. As mentioned below, a carbon material shows good dispersibility in this polyacid. On the other hand, by a method in which only a carbon material is mixed with an electroconductive polymer solution containing a polysulfonic acid or a salt thereof doped to an electroconductive polymer, the dispersibility of the carbon material is decreased and a sufficient electroconductivity is not obtained.

As a solution containing an electroconductive polymer mixed with a mixture of a polyacid and a carbon material, a commercially available material can be used, and a solution containing an electroconductive polymer produced by the method mentioned below can also be used.

In the electroconductive polymer solution of the present invention, since the hydrophilic functional group contained in the surface of the carbon material has good affinity with a hydrophilic group contained in the polyacid, the carbon material is uniformly dispersed near the polyacid without aggregation by an ion interaction. By this, it is thought that the electroconductive polymer solution of the present invention has excellent dispersibility of the carbon material. Note that, the “near” means the neighborhood of the hydrophilic group of the polyacid.

The content of the carbon material in the electroconductive polymer solution is preferably 0.1 part by mass or more and 15 parts by mass or less with respect to 100 parts by mass of the polyacid, is more preferably 0.5 part by mass or more and 10 parts by mass or less, and is further preferably 1 part by mass or more and 5 parts by mass or less.

Also, according to the second production method mentioned below, it is thought that an electroconductive polymer solution having excellent dispersibility can be obtained by coating at least a part of the carbon material with the electroconductive polymer. Note that, the “coated” means a state in which the electroconductive polymer coats at least a part of the surface of the carbon material. It can be determined whether or not to be coated by the visual observation using a scanning electron microscope or the like. Also, at least a part of the carbon material may be coated with the electroconductive polymer to become a complex.

Examples of the electroconductive polymer include substituted or non-substituted polythiophenes, substituted or non-substituted polypyrroles, substituted or non-substituted polyanilines, substituted or non-substituted polyacetylenes, substituted or non-substituted poly(p-phenylene)s, substituted or non-substituted poly(p-phenylene vinylene)s, substituted or non-substituted poly(thienylene vinylene)s, and derivatives thereof. Among these, poly(3,4-ethylenedioxythiophene)s having a structural unit represented by following formula (1) are preferable from the standpoint of the heat stability.

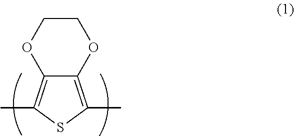

As a dopant, a polysulfonic acid or a salt thereof which functions as a dopant to the electroconductive polymer is used. Specific examples of the polysulfonic acid include polyacryl resins having a substituted or non-substituted sulfonic acid group such as poly(2-acrylamide-2-methylpropane sulfonic acid)s, polyvinyl resins having a substituted or non-substituted sulfonic acid group such as polyvinyl sulfonic acids, polystyrene resins having a substituted or non-substituted sulfonic acid group such as polystyrene sulfonic acids, polyester resins having a substituted or non-substituted sulfonic acid group such as polyester sulfonic acids, and copolymers consisting of one or more kinds selected from these. Specific examples of the salt composing the salt of the polysulfonic acid include lithium salts, sodium salts, potassium salts, and ammonium salts. Among the above materials, polystyrene sulfonic acids having a structural unit represented by following formula (2) are preferable. The polysulfonic acid or the salt thereof which functions as a dopant can be used alone or in combination with two or more kinds.

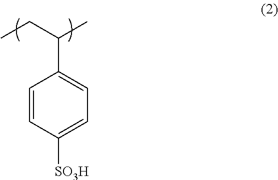

The weight average molecular weight of the polyacid used in the present invention is preferably 2,000 to 500,000 in order to stably keep the good dispersibility of the carbon material. Further, in order to obtain a high electroconductivity, it is more preferably 5,000 to 300,000, and is further preferably 10,000 to 200,000. The weight average molecular weight can be measured by GPC (gel permeation chromatography).

In the case that only a low molecular acid compound except for a polyacid is used, the carbon material does not show sufficient dispersibility, and an electroconductive polymer material having a high electroconductivity like the present invention cannot be obtained. The evaluation of the dispersibility in the electroconductive polymer solution can be confirmed by a confirmation of sedimentation and separation by visual inspection, a viscosity measurement, or a particle size distribution measurement by laser diffraction or dynamic light scattering.

For example, water, a mixture of a water-miscible organic solvent and water, or the like can be used as the solvent of the electroconductive polymer solution of the present invention. Specific examples of the organic solvent include alcohol solvents such as methanol, ethanol, and propanol, aromatic hydrocarbon solvents such as benzene, toluene, and xylene, aliphatic hydrocarbon solvents such as hexane, aprotic polar solvents such as N,N-dimethylformamide, dimethylsulfoxide, acetonitrile, and acetone. The organic solvent can be used alone, or in combination with two or more kinds. The organic solvent preferably contains at least one selected from water/alcohol solvents and aprotic polar solvents.

As a carbon material contained in the electroconductive polymer solution of the present invention, a general material that is widely used can be used. For example, it is possible to use at least one or more kinds selected from carbon blacks such as acetylene black and Ketjen black, vapor-grown carbons such as VGCF, active carbons, and graphite. Also, it is possible to use carbon materials in which hydrophilic processing is conducted by giving a hydrophilic group by oxidation treatment, for example.

In the present invention, a solution containing an electroconductive polymer and a polysulfonic acid or a salt thereof which functions as a dopant may be in a solution state or in a dispersion state. In the case of the dispersion state, the average particle diameter can be in a range of several nm to several μm, and can have a single dispersion peak or plural dispersion peaks. In a dispersion solution, the carbon material can be used in a dispersion state.

At least a hydrophilic group providing hydrophilic property such as carboxyl group or hydroxyl group preferably exists on the surface of the carbon material for the uniform dispersion with stability. Note that, these surface functional groups can be removed by a heat treatment of the carbon material. In general, it is known that oxygen-containing groups such as carboxyl group and hydroxyl group and hydrogen-containing group such as quinone group and hydrogen are respectively disappeared at a lower temperature and a higher temperature than around 400 to 500° C. For example, depending on the amount of the hydrophilic group contained in the polyacid, it can be used with appropriately adjusting the amount of the surface functional group of the carbon. As for the method for quantitating the surface functional group, it can be quantitated by neutralizing the surface functional group showing acidity with various alkalis.

The carbon material can be used with no limitation regarding the shape which may be a fibrous, granular such as spherical, scaly, or a nanotube, but it is valid to choose the shape of the carbon material from these depending on the film thickness or the smoothness which is desired for the electroconductive polymer material. For example, since the thickness desired for a solid electrolyte of a solid electrolytic capacitor is around several μm, a granular carbon material is preferably used. Also, a granular carbon material is preferably used from the standpoint with good dispersibility, too. On the other hand, it is relatively difficult to uniformly disperse a nanotube or the like with stability.

The specific surface area of the carbon material is not particularly limited, but a carbon material having a larger specific surface area is preferable because a high electroconductivity can be given even when the content is small. For example, Ketjen black and active carbons are preferable.

The amount of the carbon material contained in the electroconductive polymer solution is not particularly limited, but in the case of a small amount, there is a possibility that an electroconductivity does not sufficiently improved. On the other hand, in the case of a large amount, there is a possibility that the sedimentation of the carbon material occurs or that the film formation property of the electroconductive polymer material obtained by removing the solvent is decrease. From the standpoint of preventing these, the amount of the carbon material is preferably in a range of 0.5 to 5 mass % with respect to the amount of the electroconductive polymer, and is more preferably in a range of 0.8 to 3 weight %.

The concentration of the electroconductive polymer contained in the electroconductive polymer solution is preferably 0.1 to 20 mass % with respect to the amount of the solution in total from the standpoint that the dispersibility can be maintained in the long term, and is more preferably 0.5 to 10 mass %.

When a carbon material is mixed with an electroconductive polymer solution, a mixture, which is obtained by previously supplying a carbon material in a desired powdery state to a polyacid and by stirring it with a generally-known mechanical stirring device at normal temperature, is preferably mixed with a solution containing an electroconductive polymer and a polysulfonic acid. By this, an electroconductive polymer solution in which a carbon material is uniformly dispersed can easily be obtained without a step to pulverize the carbon material using a ball mill or the like. Thus, it is not necessary to use an electroconductive carbon paste in which a carbon material is previously dispersed by containing a surfactant or the like. In this way, since it is not necessary to use a surfactant or the like to improve the dispersibility of the carbon material, the carbon material can be uniformly dispersed even in a high acidic solution (pH: 2 or less) in which a surfactant generally comes to be unstable. Further, a degassing step may be conducted after stirring.

A resin which has a binding action and which functions as a binder can further be added to the electroconductive polymer solution. Specific examples of this resin include polyester resins, polyethylene resins, polyamide resins, polyimide resins, polyether resins, and polystyrene resins. Also, in order to remove the solvent from the electroconductive polymer solution, it is allowed in the drying stage to add, for example, a dicarboxylic acid such as phthalic acid, a hydroxyl group-substituted polymer or low molecular compound, or the like, which is a component in which an ester is synthesized likewise due to the binding action. In order not to damage the dispersibility of the carbon material in the electroconductive polymer solution, it is preferable to mainly add a component consisting of a latter low molecular compound having a hydrophilic group and to dehydrate it by heating to become a binder. The amount added of the resin is preferably 0.01 to 20 parts by mass with respect to 100 parts by mass of the electroconductive polymer solution from the standpoint that the electroconductivity is not damaged.

Next, the method for producing an electroconductive polymer solution according to the present invention is explained.

The first method for producing an electroconductive polymer solution of the present invention has a step of obtaining an electroconductive polymer by an oxidative polymerization using an oxidant in a solution which contains at least one monomer selected from the group consisting of pyrrole, thiophene, and derivatives thereof as a monomer providing an electroconductive polymer, a polysulfonic acid which functions as a dopant, and a solvent; and a step of mixing a mixture of a polyacid and a carbon material with the electroconductive polymer.

The second method for producing an electroconductive polymer solution of the present invention has a step of obtaining an electroconductive polymer by an oxidative polymerization of at least one monomer selected from the group consisting of pyrrole, thiophene, and derivatives thereof as a monomer providing an electroconductive polymer using an oxidant in a solution which contains a mixture of a polyacid and a carbon material, a polysulfonic acid which functions as a dopant, and a solvent.

According to these production methods, it is possible to produce an electroconductive polymer solution in which a carbon material is uniformly dispersed.

Specifically, in the first method, a mixture in which a carbon material is uniformly dispersed near a polyacid is mixed with a solution containing an electroconductive polymer. By using a polyacid having good solubility and compatibility to a solution containing an electroconductive polymer, a carbon material can be uniformly dispersed with a polyacid in a solution containing an electroconductive polymer.

In the second method, a polysulfonic acid which functions as a dopant and a monomer is polymerized by oxidation polymerization in a state in which a carbon material is uniformly dispersed near a polyacid to polymerize an electroconductive polymer, and thereby an electroconductive polymer solution in which a carbon material is uniformly dispersed can be obtained. This is thought to be because at least a part of the carbon material is coated with an electroconductive polymer. Also, this is thought to be because at least a part of the carbon material is coated with an electroconductive polymer to become a complex.

As the monomer, it is possible to use the above-mentioned monomers providing an electroconductive polymer, such as pyrrole, thiophene, and derivatives thereof. From the standpoint of heat stability, 3,4-ethylenedioxythiophene is preferable.

The oxidant is not particularly limited, and it is possible to use iron (III) salts of an inorganic acid such as iron (III) chloride hexahydrate, anhydrous iron (III) chloride, iron (III) nitrate nonahydrate, anhydrous ferric nitrate, iron (III) sulfate n-hydrate (n=3 to 12), ammonium iron (III) sulfate dodecahydrate, iron (III) perchlorate n-hydrate (n=1, 6), and iron (III) tetrafluoroborate; copper (II) salts of an inorganic acid such as copper (II) chloride, copper (II) sulfate, and copper (II) tetrafluoroborate; nitrosonium tetrafluoroborate; salts of a persulfate such as ammonium persulfate, sodium persulfate, and potassium persulfate; salts of a periodate such as potassium periodate; hydrogen peroxide, ozone, potassium hexacyanoferrate tetraammonium cerium (IV) sulfate dihydrate, bromine, and iodine; and iron (III) salts of an organic acid such as iron (III) p-toluenesulfonic acid. This may be used alone or in combination with two or more kinds.

The used amount of the oxidant is not particularly limited, but is preferably 0.5 to 100 parts by mass with respect to 1 part by mass of the monomer from the standpoint that a polymer having a high electroconductivity is obtained by a milder reaction under oxygen atmosphere, and is more preferably 1 to 40 parts by mass.

The oxidation polymerization may be chemical oxidation polymerization or an electrolytic oxidation polymerization. The chemical oxidation polymerization is preferably carried out with stirring. The reaction temperature of the chemical oxidation polymerization is not particularly limited, but the upper limit can be the reflux temperature of the solvent used. For example, the temperature is preferably 0 to 100° C., and is more preferably 10 to 50° C. The reaction time of the chemical oxidation polymerization depends on the kind and the used amount of the oxidant, the reaction temperature, the stirring condition, and the like, but is preferably 5 to 100 hours.

The electroconductive polymer solution obtained may contain a component which is unnecessary to develop the electroconductivity such as an unreacted monomer or a residual component derived from the oxidant. In this case, the component is preferably removed by extraction by ultrafiltration or centrifugal separation, ion-exchange treatment, dialysis treatment, or the like. Note that, the unnecessary component contained in the electroconductive polymer solution is quantitated by ICP emission analysis, ion chromatography, UV absorption, or the like.

Next, an embodiment of the electroconductive polymer material according to the present invention is explained. The electroconductive polymer material according to the present invention can be obtained by removing the solvent from the electroconductive polymer solution according to the present invention. Since the material includes a carbon material and the carbon material is uniformly dispersed, it has a high electroconductivity. Specifically, in an electroconductive polymer matrix containing an electroconductive polymer, a polysulfonic acid which functions as a dopant, polyacid, and a carbon material, the carbon material is placed near the polyacid. Further, at least a part of the carbon material is coated with the electroconductive polymer. Also, at least a part of the carbon material may be coated with the electroconductive polymer to become a complex.

A film of the electroconductive polymer material or the like can be obtained by forming an electroconductive polymer solution existing domain on a desired substrate by a general method such as drop, application, immersion, print or coater, and by drying it at a desired temperature to remove the solvent from the electroconductive polymer solution. The drying temperature is not particularly limited as long as it is a temperature which is equal to or lower than the decomposition temperature of the electroconductive polymer, but is preferably 300° C. or lower.

The electroconductive polymer material according to the present invention has a high electroconductivity in comparison with an electroconductive polymer material which does not contain a carbon material because the electroconductive carbon material is uniformly dispersed near the polyacid, which does not have an electroconductivity, and give it an electroconductivity. On the other hand, the film formation property is not damaged in comparison with an electroconductive polymer material which does not contain a carbon material. Also, as for the surface state of the film of electroconductive polymer material according to the present invention, the surface roughness is changed depending on the kind and the amount of the carbon material contained. The surface roughness can be observed with a general surface roughness meter, an atomic force microscope (AFM), a non-contact surface texture measuring apparatus, or the like.

Next, an embodiment of the solid electrolytic capacitor and the method for producing the same according to the present invention is explained. The solid electrolytic capacitor according to the present invention has an anode conductor containing a valve metal, an dielectric layer formed on a surface of the anode conductor, and a solid electrolyte layer formed on the dielectric layer, in which this solid electrolyte layer contains the electroconductive polymer material according to the present invention obtained by removing the solvent from the electroconductive polymer solution according to the present invention. Since the electroconductive polymer material according to the present invention has a high electroconductivity, a solid electrolytic capacitor having a low ESR can be obtained.

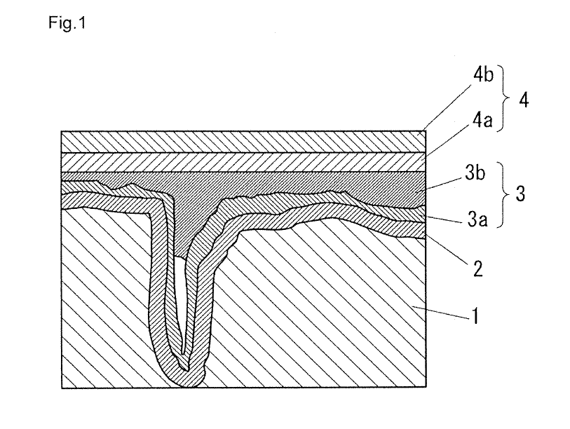

FIG. 1 is a schematic enlarged sectional view showing a part of a conformation in one embodiment of the solid electrolytic capacitor according to the present invention. This solid electrolytic capacitor has a conformation formed by laminating dielectric layer 2, solid electrolyte layer 3, and cathode conductor 4 in this order on anode conductor 1.

Anode conductor 1 is formed of: a plate, a foil, or a wire of a valve metal; a sintered body containing a fine particle of a valve metal; a porous body metal subjected to a surface area enlargement treatment by etching; or the like. Examples of the valve metal include tantalum, aluminum, titanium, niobium, zirconium, and alloys thereof. Among these, at least one valve metal selected from aluminum, tantalum, and niobium is preferable. Dielectric layer 2 is a layer which can be formed by an electrolytic oxidation of the surface of anode conductor 1, and is also formed in the pores of a sintered body or a porous body. The thickness of dielectric layer 2 can be appropriately adjusted by the voltage of the electrolytic oxidation.

Solid electrolyte layer 3 is a layered portion containing the electroconductive polymer material according to the present invention which is obtained by removing the solvent from the electroconductive polymer solution according to the present invention. Solid electrolyte layer 3 may have a one-layered conformation of a layered portion containing the electroconductive polymer material according to the present invention or may have a two-layered conformation of first solid electrolyte layer 3a and second solid electrolyte layer 3b as shown in FIG. 1. Examples of the method for forming solid electrolyte layer 3 in the case of the one-layered conformation include a method by carrying out an application or an impregnation of the electroconductive polymer solution according to the present invention on dielectric layer 2 and by removing the solvent from the electroconductive polymer solution.

Solid electrolyte layer 3 of the two-layered conformation of first solid electrolyte layer 3a and second solid electrolyte layer 3b as shown in FIG. 1 can be formed as follows. First, a chemical oxidation polymerization or an electropolymerization of a monomer that is a material of an electroconductive polymer is carried out on dielectric layer 2 to form first solid electrolyte layer 3a containing the electroconductive polymer. Then, an application or an impregnation of the electroconductive polymer solution according to the present invention is carried out on first solid electrolyte layer 3a, and the solvent is removed from the electroconductive polymer solution to form second solid electrolyte layer 3b containing the electroconductive polymer material according to the present invention.

As a monomer for forming first solid electrolyte layer 3a, it is possible to use at least one selected from pyrrole, thiophene, aniline, and derivatives thereof. As a dopant used for chemical oxidation polymerization or electropolymerization of this monomer to obtain an electroconductive polymer, sulfonic acid-type compounds such as alkyl sulfonic acids, benzene sulfonic acid, naphthalene sulfonic acid, anthraquinone sulfonic acid, camphor sulfonic acid, iron salts thereof, and derivatives thereof are preferable. The molecular weight of the dopant can appropriately be selected from low molecular weight compounds and high molecular weight compounds. As the solvent, it is possible to use water or a mixed solvent containing water and a water-soluble organic solvent.

The electroconductive polymer contained in first solid electrolyte layer 3a and the electroconductive polymer contained in second solid electrolyte layer 3b preferably contain the same kind of polymer.

Further, solid electrolyte layer 3 may contain an electroconductive polymer obtained by polymerizing pyrrole, thiophene, aniline, or a derivative thereof; an oxide derivative such as manganese dioxide or ruthenium oxide, or an organic semiconductor such as TCNQ (7,7,8,8-tetracyanoquinodimethane complex salt).

The method for the application or the impregnation of the electroconductive polymer solution is not particularly limited. In order to sufficiently fill the electroconductive polymer solution into the porous pore inside, it is preferably left for several minutes to several ten minutes after the application or the impregnation. Also, the immersion is preferably repeated, and the immersion is preferably carried out in a reduced-pressured or pressurized form.

The solvent can be removed from the electroconductive polymer solution by drying the electroconductive polymer solution. The drying temperature is not particularly limited as long as it is in a temperature range at which the solvent can be removed, but the upper limit is preferably lower than 300° C. from the standpoint of preventing the element deterioration by heat. The drying time can appropriately be optimized by the drying temperature, but is not particularly limited as long as the electroconductivity is not damaged.

The material of cathode conductor 4 is not particularly limited as long as it is a conductor. For example, as shown in FIG. 1, it can be designed to have a two-layered conformation consisting of carbon layer 4a such as graphite and silver electroconductive resin layer 4b.

### EXAMPLES

As follows, specific examples of the present embodiment are shown, but the present embodiment is not limited to these.

### Reference Example

The results obtained by experiments for evaluating dispersibility of a carbon material in a polyacid are explained. Aqueous solutions of commercially available polystyrene sulfonic acids with a weight average molecular weight of 2,000, 10,000, 50,000, and 500,000, and of 2-naphthalene sulfonic acid, which were prepared at 1 mass % respectively, and pure water were provided. With these solutions or pure water, Ketjen black EC600JD (trade name, made by Ketjen black International Co. Ltd, hereinafter, referred to as Ketjen black) were each mixed in an amount of 0.027 g with respect to 100 g of each solution (Solutions 1 to 6). Note that, with the polystyrene sulfonic acid solution, 2.7 mass % of Ketjen black with respect to the mass of the polystyrene sulfonic acid was mixed. Then, each solution was stirred for 1 hour, and it was left for 1 day. By visual inspection, dispersion stabilities of Ketjen black, namely states of sedimentation and separation were evaluated. The evaluation results are shown in TABLE 1.

TABLE 1

| | | weight | | |
|---|---|---|---|---|
| | | average | content of | |
| sam- | kind of | molecular | Ketjen black | dispersion |
| ple | solution | weight | (mass %) | stability |
| Sol. 1 | polystyrene | 2,000 | 2.7 | no sedimentation |
| | sulfonic acid | | | and separation |
| Sol. 2 | aqueous | 10,000 | | no sedimentation |
| Sol. 3 | solution | 50,000 | | and separation |
| Sol. 4 | | 500,000 | | (stable for 1 week |
| | | | | or longer) |
| Sol. 5 | 2-naphthalene | low | | occurrence of |
| | sulfonic acid | molecular | | sedimentation |
| | aqueous | | | and separation |
| | solution | | | (incompatible, |
| Sol. 6 | pure water | — | | hardly dispersed) |

As shown in TABLE 1, the carbon material was stably dispersed in Solutions 1 to 4 in which a polystyrene sulfonic acid, that was a polyacid, was used. This is thought to be because the carbon material is dispersed near the polystyrene sulfonic acid in a state along the molecular chain as described above. On the other hand, in Solutions 5 and 6 in each of which an aqueous solution of 2-naphthalenesulfonic acid that was a low molecular organic sulfone acid compound or water was used, the dispersibility was poor, and sedimentation and separation of the carbon material were observed. Also, as compared by the difference of the weight average molecular weight of the polystyrene sulfonic acid, Solution 1 in which the polymer chain was shortest had a poorer longer-term stability than those of Solutions 2 and 4. From this, it is thought that the dispersion effect of the carbon material can be improved by using a polyacid designed so that it has a moderate molecular weight distribution.

Then, 50 μl of Solutions 2, 3, and 6 were dropped on a glass substrate, and they were dried at 120° C. for 30 minutes. As for the dried materials obtained, the measurement of the surface resistivity by four-point probe method (trade name: Loresta-GP MCP-T60, made by Mitsubishi Chemical Corporation) and the observation of the appearance were conducted. The results are shown in TABLE 2.

TABLE 2

| | | weight | content of | | |
|---|---|---|---|---|---|
| | | average | Ketjen | surface | appearance |
| sam- | kind of | molecular | black | resistivity | of dried |
| ple | solution | weight | (mass %) | (Ωsq.) | material |
| Sol. 2 | poly- | 10,000 | 2.7 | 10⁻⁵ | film |
| Sol. 3 | styrene | 50,000 | | 10⁻⁴ | (Ketjen black |
| | sulfonic acid | | | | is uniformly |
| | aqueous | | | | sprinkled) |
| | solution | | | | |
| Sol. 6 | pure water | — | | 10⁻² | powdery |

As shown in TABLE 2, in Solutions 2 and 3 in which the carbon material was stable dispersed, the appearance of the dried material was a film, and it was observed that the black carbon material was uniformly sprinkled (dispersed) in the film with no segregation. From the surface resistivity of this dried material, it was confirmed that this dried material had an electroconductivity which was approximately intermediate between the insulation property of the polystyrene sulfonic acid and the electroconductivity of the carbon material. On the other hand, in Solution 6, the dries material was obtained in a powdery state, and it became clear that the carbon material was not dispersed.

### Example 1

Next, the results of producing the electroconductive polymer solution of the present invention and of carrying out evaluation are explained. The electroconductive polymer solution of this Example was produced by mixing 5 g of above-mentioned Solution 3 with 10 g of a commercially available 1.3 mass % electroconductive polymer solution (trade name: Clevios, made by H. C. Starck) of a poly(3,4-ethylenedioxythiophene)-polystyrene sulfonic acid in which a polystyrene sulfonic acid was doped and by then stirring it at normal temperature for 3 hours. At this time, the color of the solution was changed from navy blue to dark navy blue. When observed with SEM, the Ketjen black powder was existed in a granular state in the electroconductive polymer solution, and a secondary aggregate with a size of approximately 5 μm to 30 μm was formed.

As for the electroconductive polymer solution obtained, the measurement of the particle size distribution by dynamic light scattering method and the measurement of the solution viscosity were conducted. Further, 50 μl of the electroconductive polymer solution was dropped on a glass substrate, and it was dried at 120° C. for 30 minutes to form an electroconductive polymer film. The surface resistivity of the electroconductive polymer film was measured by four-point probe method, and the surface roughness was measured using a non-contact surface texture measuring apparatus (trade name: PF-60, made by Mitaka Kohki Co., Ltd.). The results are shown in TABLE 3.

### Comparative Example 1

An electroconductive polymer solution was produced and evaluated in the same manner as in Example 1 except that Ketjen black was not mixed and that Solution 3 prepared was used. The results are shown in TABLE 3.

TABLE 3

| | | | | electroconductive | |
|---|---|---|---|---|---|
| | | electroconductive | | polymer film | |
| | | polymer solution | | | surface |
| | | average | | | roughness |
| | | particle | solution | surface | (μm) (Ra, |
| | Ketjen | diameter | viscosity | resistivity | arithmetic |
| | black | (nm) | (mPa · s) | (Ωsq.) | average height) |
| Ex.1 | presence | 273.5 | 23.1 | 69.7 | 0.5126 |
| Comp. | absence | 270.2 | 25.3 | 91.2 | 0.2538 |
| Ex. 1 | | | | | |

As shown in TABLE 3, when the case (Example 1) of mixing a carbon material in an electroconductive polymer solution containing a polystyrene sulfonic acid was compared to the case (Comparative Example 1) of not mixing it, the average particle diameter was approximately the same. On the other hand, since the solution viscosity in the case of mixing a carbon material is lower than in the case of not mixing a carbon material, it is suggested that the dispersibility of the carbon material is also high even when the carbon material is mixed. Although the carbon material before mixing was in a secondary aggregate form with around several ten μm, it was thought that the aggregate was disaggregated in the solution by the above-mentioned action and was finely dispersed near the polysulfonic acid. The surface resistivity of the electroconductive polymer film of Example 1 was approximately 20% lower than that of Comparative Example 1, and had a high electroconductivity. This is thought to be because the electroconductivity was given to the polystyrene sulfonic acid by the carbon material, and thereby the electroconductivity of the electroconductive polymer material was improved. Also, the surface of the electroconductive polymer film of Example 1 had a larger asperity than that of Comparative Example 1, and the change of the surface roughness was observed.

### Example 2

Then, specific examples of the solid electrolytic capacitor of the present invention and the method for producing the same are explained. In this Example, a solid electrolytic capacitor having two solid electrolyte layers as shown in FIG. 1 was produced. Porous aluminum was used as anode conductor 1 containing a valve metal. As dielectric layer 2, an oxide film was formed on the surface of aluminum metal by anodic oxidation. Then, anode conductor 1 in which dielectric layer 2 was formed was immersed in 3,4-ethylenedioxythiophene solution as a monomer. After that, it was immersed in and taken out from an oxidant liquid in which 20 g of p-toluenesulfonic acid as a dopant and 10 g of ammonium persulfate as an oxidant were dissolved in 100 ml of pure water, and it was polymerized for 1 hour. These operations were repeated 5 times and chemical oxidation polymerization was carried out to form first solid electrolyte layer 3a. The electroconductive polymer solution produced in Example 1 was dropped on first solid electrolyte layer 3a, and was dried and solidified at 150° C. to form second solid electrolyte layer 3b. On second solid electrolyte layer 3b, a graphite layer as carbon layer 4a and a silver-containing resin layer as silver electroconductive resin layer 4b were formed in this order to obtain a solid electrolytic capacitor. 30 solid electrolytic capacitors were produced.

The ESR of the solid electrolytic capacitor obtained was measured using an LCR meter at a frequency of 100 kHz. The ESR value was standardized from the value of the total cathode area to the value of the unit area (1 cm²). Also, the LC (leakage current) was measured by applying a rated voltage to the solid electrolytic capacitor. The LC value was standardized by dividing it by a CV product (capacity*voltage). The average values of the results by the above-mentioned measurements of the 30 solid electrolytic capacitors are shown in TABLE 4.

### Example 3

A solid electrolytic capacitor was produced and evaluated in the same manner as in Example 2 except that porous tantalum was used as anode conductor 1 containing a valve metal. The results are shown in TABLE 4.

### Comparative Example 2

A solid electrolytic capacitor was produced and evaluated in the same manner as in Example 2 except that the electroconductive polymer solution produced in Comparative Example 1 was used in the step of forming second solid electrolyte layer 3b. The results are shown in TABLE 4.

TABLE 4

| | electroconductive | ESR | LC |
|---|---|---|---|
| | polymer solution | (mΩ · cm²) | (CV) |
| Ex. 2 | Ex. 1 | 1.72 | 0.049 |
| Ex. 3 | Ex. 1 | 1.84 | 0.051 |
| Comp. Ex. 2 | Comp. Ex. 1 | 2.01 | 0.053 |

As shown in TABLE 4, when an electroconductive polymer material containing a carbon material is used as the solid electrolyte of the solid electrolytic capacitor, it is possible to obtain a capacitor with a low ESR without increasing the LC. This is thought to be because the electroconductive polymer film has a high electroconductivity, and because the surface conformation of the electroconductive polymer film is roughly reformed, and thereby the interface contact with the carbon layer formed on the electroconductive polymer film is good and the adhesion is improved. The reason that the LC value is not increased is thought to be because the carbon material is uniformly dispersed near the polysulfonic acid resin, and thereby the carbon material is not solely deposited on the surface to be contact directly to the surface of the valve metal.

As described earlier, it has been confirmed that an electroconductive polymer material having a high electroconductivity can be obtained by containing a mixture of a polyacid and a carbon material in an electroconductive polymer solution which contains an electroconductive polymer, a polysulfonic acid which functions as a dopant, and a solvent. Also, it has been confirmed that a solid electrolytic capacitor with a low ESR can be obtained without increasing the LC by using the above-mentioned electroconductive polymer material.

### Example 4

0.65 g of 3,4-ethylenedioxythiophene was supplied to a mixed solution consisting of 100 g of pure water and 3.62 g of a 20 mass % polystyrene sulfonic acid (weight average molecular weight 5×10⁴), and it was stirred at normal temperature for 5 minutes. Then, iron (III) sulfate and ammonium persulfate were further supplied as an oxidant, and it was further stirred at normal temperature for 50 hours (1,000 rpm) to carry out oxidation polymerization. By this, an electroconductive polymer solution which contains 1.3 mass % of an electroconductive polymer component consisting of a poly(3,4-ethylenedioxythiophene) and a polystyrene sulfonic acid was obtained. The color of the solution was changed from pale yellow to navy blue. Then, an amphoteric ion exchange resin (trade name: MB-1, made by ORGANO CORPORATION, ion-exchange type: —H, —OH) was supplied to this solution, and it was stirred for 30 minutes. By this, an unnecessary component derived from the oxidant was removed. 10 g of this solution was taken, and 0.41 g of dimethylsulfoxide was mixed as a solvent and it was further stirred for 30 minutes. Then, after mixing 5 g of above-mentioned Solution 3, it was stirred at normal temperature for 3 hours to obtain a navy blue electroconductive polymer solution.

As for the electroconductive polymer solution obtained, an electroconductive polymer film was produced in the same manner as in Example 1, and the surface resistivity was measured. Also, a solid electrolytic capacitor was produced in the same manner as in Example 2, and the ESR and the LC were measured. The results are shown in TABLE 5.

### Example 5

After mixing 5 g of above-mentioned Solution 3 with a mixed solution consisting of 100 g of pure water and 3.61 g of a 20 mass % polystyrene sulfonic acid (weight average molecular weight 5×10⁴), it was stirred for 1 hour. Then, 0.65 g of 3,4-ethylenedioxythiophene was supplied, and it was stirred at normal temperature for 5 minutes. After that, iron (III) sulfate and ammonium persulfate were further supplied as an oxidant, and it was further stirred at normal temperature for 50 hours (1,000 rpm) to carry out oxidation polymerization. By this, an electroconductive polymer solution which contains 1.3 mass % of an electroconductive polymer component consisting of a poly(3,4-ethylenedioxythiophene) and a polystyrene sulfonic acid was obtained. Then, an amphoteric ion exchange resin (trade name: MB-1, made by ORGANO CORPORATION, ion-exchange type: —H, —OH) was supplied to this solution, and it was stirred for 30 minutes. By this, an unnecessary component derived from the oxidant was removed. 10 g of this solution was taken, and 0.41 g of dimethylsulfoxide was mixed as a solvent and it was further stirred for 30 minutes to obtain a navy blue electroconductive polymer solution.

As for the electroconductive polymer solution obtained, an electroconductive polymer film was produced in the same manner as in Example 1, and the surface resistivity was measured. Also, a solid electrolytic capacitor was produced in the same manner as in Example 2, and the ESR and the LC were measured. The results are shown in TABLE 5.

### Comparative Example 3

An electroconductive polymer solution was produced in the same manner as in Example 4 except that above-mentioned solution 3 was not mixed.

As for the electroconductive polymer solution obtained, an electroconductive polymer film was produced in the same manner as in Example 1, and the surface resistivity was measured. Also, a solid electrolytic capacitor was produced in the same manner as in Example 2, and the ESR and the LC were measured. The results are shown in TABLE 5.

TABLE 5

| | |
|---|---|
| electroconductive | |
| polymer film | solid electrolytic capacitor |

| | surface resistivity | ESR | LC |
|---|---|---|---|
| | (Ωsq.) | (mΩ · cm²) | (CV) |
| Ex. 4 | 49.5 | 1.52 | 0.048 |
| Ex. 5 | 55.6 | 1.59 | 0.055 |
| Comp. Ex. 3 | 75.1 | 1.91 | 0.059 |

As shown in TABLE 5, the electroconductive polymer films produced by using the electroconductive polymer solutions obtained by the methods for manufacturing in Examples 4 and 5 had a low surface resistivity and a high electroconductivity. Also, there was no increase of the LC, and it was possible to obtain a solid electrolytic capacitor with a low ESR. These results are thought to show that the above-mentioned actions result in the effect.

Note that, it is obvious that the present invention is not limited to the above-mentioned embodiments and the Examples, and the present invention can be changed in design depending on the purpose and the use. For example, materials such as electroconductive polymer solutions, dopants, carbon materials, and solvents which are used in the present invention can optionally be selected from the above-mentioned materials, as well as from the materials except for the above-mentioned materials which satisfy the requirement stipulated in the present invention. Also, in the electroconductive polymer solution of the present invention, it is thought that an electroconductive polymer solution having an excellent dispersibility is obtained by containing at least a mixture of a polyacid and a carbon material.

The present application claims the priority based on Japanese Patent Application No. 2011-41168, filed on Feb. 28, 2011, all the disclosure of which is incorporated herein by reference.

The present invention was explained with reference to embodiments and Examples, but the present invention is not limited to the above-mentioned embodiments and the Examples. In the constituents and the detail of the present invention, various changings which are understood by a person ordinarily skilled in the art can be made within the scope of the present invention.

### REFERENCE SIGNS LIST

1 anode conductor
2 dielectric layer
3 solid electrolyte layer
3a first solid electrolyte layer
3b second solid electrolyte layer
4 cathode conductor
4a carbon layer
4b silver electroconductive resin layer

1. An electroconductive polymer solution, comprising an electroconductive polymer, a polysulfonic acid or a salt thereof which functions as a dopant to the electroconductive polymer, a mixture of a polyacid and a carbon material, and a solvent.

2. The electroconductive polymer solution according to claim 1, wherein the carbon material is dispersed near the polyacid.

3. The electroconductive polymer solution according to claim 1, wherein at least a part of the carbon material is coated with the electroconductive polymer.

4. The electroconductive polymer solution according to claim 1, wherein the carbon material comprises a hydrophilic group on a surface thereof.

5. The electroconductive polymer solution according to claim 1, wherein the carbon material is granular.

6. The electroconductive polymer solution according to claim 1, wherein the carbon material is at least one selected from the group consisting of active carbon and carbon black.

7. The electroconductive polymer solution according to claim 1, wherein the content of the carbon material is 0.5 to 5 mass % with respect to the mass of the electroconductive polymer.

8. The electroconductive polymer solution according to claim 1, wherein the polyacid is at least one selected from the group consisting of polystyrene resins comprising a sulfonic acid group, polyvinyl resins comprising a sulfonic acid group, and polyester resins comprising a sulfonic acid group.

9. The electroconductive polymer solution according to claim 1, wherein the weight average molecular weight of the polyacid is 2,000 to 500,000.

10. The electroconductive polymer solution according to claim 1, wherein the polyacid does not function as a dopant of the electroconductive polymer

11. A method for producing the electroconductive polymer solution according to claim 1, comprising:
obtaining an electroconductive polymer by an oxidative polymerization using an oxidant in a solution which comprises at least one monomer selected from the group consisting of pyrrole, thiophene, and derivatives thereof as a monomer providing an electroconductive polymer, a polysulfonic acid or a salt thereof which functions as a dopant, and a solvent; and
mixing a mixture of a polyacid and a carbon material with the electroconductive polymer.

12. A method for producing the electroconductive polymer solution according to claim 1, comprising:
obtaining an electroconductive polymer by an oxidative polymerization of at least one monomer selected from the group consisting of pyrrole, thiophene, and derivatives thereof as a monomer providing an electroconductive polymer using an oxidant in a solution which comprises a mixture of a polyacid and a carbon material, a polysulfonic acid or a salt thereof which functions as a dopant, and a solvent.

13. An electroconductive polymer material, obtained by removing the solvent from the electroconductive polymer solution according to claim 1.

14. The electroconductive polymer material according to claim 13, wherein the carbon material is placed near the polyacid.

15. The electroconductive polymer material according to claim 13, wherein at least a part of the carbon material is coated by the electroconductive polymer.

16. A solid electrolytic capacitor, comprising an anode conductor comprising a valve metal, an dielectric layer formed on a surface of the anode conductor, and a solid electrolyte layer formed on the dielectric layer,
wherein the solid electrolyte layer comprises the electroconductive polymer material according to claim 13.

17. A solid electrolytic capacitor, comprising a solid electrolyte layer which comprises a first solid electrolyte layer and a second solid electrolyte layer,
wherein the first solid electrolyte layer comprises an electroconductive polymer obtained by a chemical oxidation polymerization or an electropolymerization of a monomer providing a electroconductive polymer, and
wherein the second solid electrolyte layer comprises the electroconductive polymer material according to claim 13.

18. A method for producing a solid electrolytic capacitor, comprising:
forming a dielectric layer on a surface of an anode conductor comprising a valve metal;
carrying out an application of the electroconductive polymer solution according to claim 1 on the dielectric layer, or carrying out an impregnation of the electroconductive polymer solution into the dielectric layer; and
removing the solvent from the electroconductive polymer solution for the application or the impregnation to form a solid electrolyte layer comprising an electroconductive polymer material.

19. A method for producing a solid electrolytic capacitor, comprising:
forming a dielectric layer on a surface of an anode conductor comprising a valve metal;
carrying out a chemical oxidation polymerization or an electropolymerization of a monomer that is a material of an electroconductive polymer on the dielectric layer, to form a first solid electrolyte layer comprising the electroconductive polymer;
carrying out an application of the electroconductive polymer solution according to claim 1 on the first solid electrolyte layer, or carrying out an impregnation of the electroconductive polymer solution into first solid electrolyte layer; and
removing the solvent from the electroconductive polymer solution for the application or the impregnation to form a second solid electrolyte layer comprising an electroconductive polymer material.
